(19) United States
(12) Patent Application Publication
(10) Pub. No.: US 2006/0206668 A1
(43) Pub. Date: Sep. 14, 2006

(54) Data processing system and data decompression method

(76) Inventor: Katsuki Uwatoko, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/362,810

(22) Filed: Feb. 28, 2006

(30) Foreign Application Priority Data
Feb. 28, 2005 (JP) 2005-053329

(51) Int. Cl. G06F 12/00

(52) U.S. Cl. 711/118

(57) ABSTRACT

Compressed data is written from a main memory into a cache memory. The capacity of decompressed data corresponding to the compressed data is calculated. To ensure that cache mis does not occur upon subsequent data writing, an address of a location in which the decompressed data is to be stored is written into the cache memory. A data area for the calculated amount of data is ensured in the cache memory. The compressed data stored in the cache memory is decompressed and then written into the area ensured in the cache memory. The decompressed data stored in the cache memory is moved to the main memory by means of a cache memory controller.

### CROSS-REFERENCE TO RELATED APPLICATIONS

This application is based upon and claims the benefit of priority from Japanese Patent Application No. 2005-053329, filed Feb. 28, 2005, the entire contents of which are incorporated herein by reference.

### BACKGROUND

1. Field

The present invention relates to a technique to decompress compressed information stored in a storage unit through the use of a cache memory.

2. Description of the Related Art

Disclosed in Japanese Unexamined Patent Publication No. 5-120131 is a device which decompresses compressed data and processes the decompressed data through the use of a cache memory. With this device, data stored on an auxiliary storage device, such as a hard disk, is stored with compression in a main storage device such as a RAM. When accessed by a CPU, the compressed data is decompressed, then stored into a cache memory and operated on by the CPU. Data compression is performed in transferring data from the auxiliary storage device to the main storage device; thus the capacity of the main storage device is increased apparently. However, nothing is referred to in the above Patent Publication about a novel configuration and usage of the cache memory.

In conventional data processing systems containing a CPU, a cache memory has been widely used which reads in part of data stored in a main memory and can be accessed quickly. Such a cache memory is provided between the CPU and the main memory. If, when the CPU makes access to the main memory, data to be accessed is present in the cache memory, the data in the cache memory is accessed. Control at this time is performed by a cache controller. Owing to the control of the cache controller, the CPU can obtain the usefulness of the cache memory even if the CPU is not conscious of the presence of the cache memory in making access to the main memory.

In the presence of data to be accessed by the CPU in the cache memory, the CPU is required to make access to the cache memory alone without making access to the main memory. Such a case is called a cache hit. The absence of data to be accessed by the CPU in the cache memory is called a cache mis.

Systems for the cache memory include a write through system and a write back system. In the write through system, when write access is a cache hit, data is written into both the cache memory and the main storage area. This system has a feature that the identity of data in the cache memory and the main storage can be kept all the time. However, since memory access to the main storage always occurs, the write access cycle is determined by the access cycle to the main storage.

With the write back system, data is written only into the cache memory on a cache hit. When data is written into the cache memory as the result of cache hit, the cache memory goes into the so-called dirty state in which the cache memory and the main storage have no identity of data. With write allocate cache, if next cache access occurs and cache mis results, so-called data allocation is performed by which a corresponding memory block in the main storage is read into the cache memory. If, at this time, the corresponding data block in the cache memory is in the dirty state, the corresponding data block in the cache memory is moved into the main storage in order for the main storage and the cache memory to keep the identity of the corresponding data block. This is called cache flash.

The feature of the write allocate type of cache memory is that, as described previously, when the CPU makes write access and cache mis results, the CPU once makes read access to the main memory and then allocates a corresponding data block in the cache memory. When the allocated data block is used twice or more, the performance will increase. However, when the allocated data block is used only once as in memory copy or compression and decompression processing, the operation of allocation is wasteful, resulting in a degradation in performance.

A device adapted to perform data allocation at the time of cache mis in an efficient manner is disclosed in Japanese Unexamined Patent Publication No. 11-312123 by way of example. In this device, a memory area used for allocation and a memory area not used for allocation are set in advance.

Even with a conventional device the object of which is to allocate data in an efficient manner at the time of cache mis, wasteful memory read at allocate time occurs to no small extent.

To prevent such a degradation in performance, the invention uses instructions to directly operate the cache memory and apparently providing corresponding blocks to those in the main memory within the cache memory, preventing wasteful memory read.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a data processing system of the invention;

FIG. 2 shows the configuration of the cache memory shown in FIG. 1;

FIG. 3 is a flowchart illustrating an outline of a data write operation including a data decompression operation of the invention

FIG. 4 is a flowchart illustrating the basic operation of data decompression processing of the invention;

FIGS. 5A through 5D show the contents of the cache in decompression processing;

FIG. 6 is a flowchart illustrating a first embodiment of the decompression processing of the invention;

FIG. 7 is a conceptual diagram of the decompression processing of the first embodiment; and

FIG. 8 is a flowchart illustrating a second embodiment of the decompression processing of the invention.

### DETAILED DESCRIPTION

Various embodiments according to the invention will be described hereinafter with reference to the accompanying drawings. In general, according to one embodiment of the invention, according to an aspect of the invention, there is provided a data processing system which has a main memory and a cache memory and processes data in accordance with the write allocate system, including: a read section which reads compressed data from the main memory and stores it into the cache memory; a calculation section which calculates the capacity of decompressed data corresponding to the compressed data stored in the cache memory; an ensuring section which ensures an area for storing data of the calculated data amount in the cache memory; a decompression section which decompresses the compressed data stored in the cache memory and storing the decompressed data in the area ensured in the cache memory; and a move section which moves the decompressed data stored in the cache memory to the main memory.

In a data processing system which adopts a write allocate type of cache memory, in decompressing compressed data, wasteful memory read at the time of cache mis can be avoided to make decompression of compressed data fast.

An embodiment of the present invention will be described hereinafter with reference to the accompanying drawings.

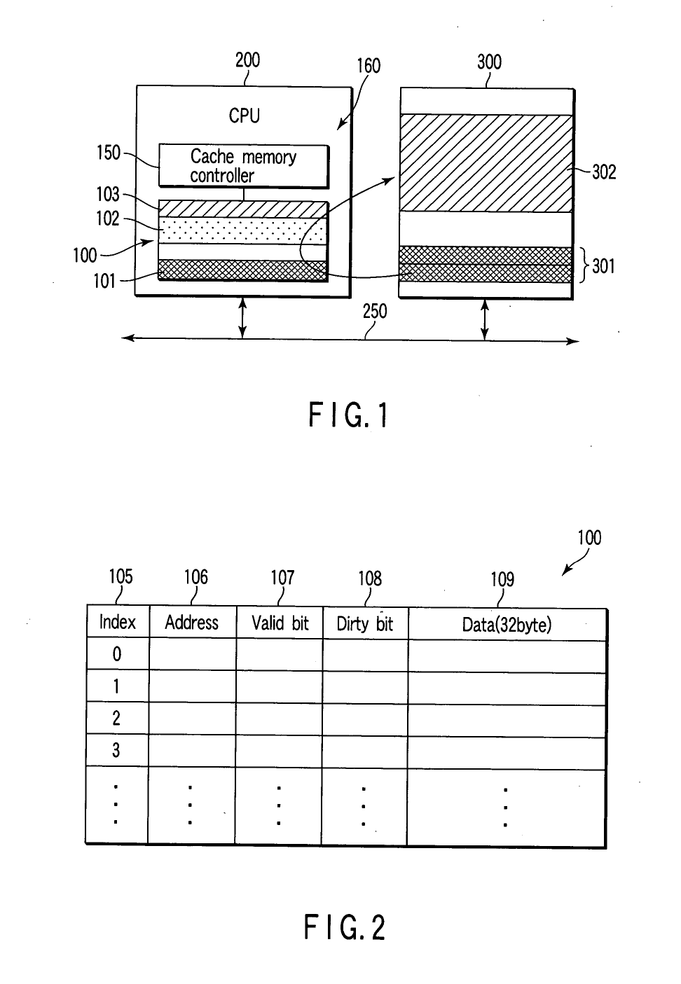

FIG. 1 is a block diagram of a data processing system of the invention.

A CPU 200 is connected by a bus 250 to a main memory 300. This system is configured such that the CPU 200 having a write allocate cache 160 decompresses compressed data 301 stored on the main memory 300 and then stores decompressed data 302 on main memory space different from that assigned to the compressed data. The write allocate cache 160 is composed of a cache memory controller (hereinafter referred to as the memory controller) 150 and a cache memory 100. The CPU 200 is constructed on one chip as an integrated circuit including the write allocate cache 160.

The compressed data 301 stored in the main memory 300 is transferred or managed in units of data blocks of a predetermined amount of data. Reference numeral 101 denotes a plurality of blocks of compressed data transferred from the main memory 300 to the cache memory 100. The compressed data 101 is decompressed by the CPU 200 and decompressed data 103 is stored into an area of the main memory 300 which differs from the area for the compressed data 301. Data 102 prior to decompression is data produced intermediately during the decompression processing. Reference numeral 302 denotes decompressed data obtained by decompressing the compressed data 301.

The capacity of the main memory 300 is sufficiently large but its speed of operation is significantly slower than that of the CPU 200. To compensate for the difference in speed of operation, the inventive system is provided with the write allocate cache 160. In comparison with the main memory 300, the cache memory 100 is smaller in capacity but much faster in speed of operation. The use of the write allocate cache 160 allows the CPU 200 to make fast memory access.

The write allocate cache 160 is a cache memory device of the write allocate type. According to this write allocate type, if, when the CPU 200 makes write access to the main memory 300, cache mis occurs, then the CPU once makes read access to the main memory and allocates a data block in the cache memory 100. That is, on the occurrence of cache mis, the memory controller 150 reads a data block in a location of an address to be accessed from the main memory 300 and then stores the data block in the cache memory 100 together with that address. After that, processing, such as computational processing, is performed on the data block stored in the cache memory 100.

In decompressing compressed data, the size of the compressed data and the size of data after being decompressed differ from each other. Therefore, in the event of cache mis, it is generally required to dynamically change the quantity of data to be read from the main memory 300 and stored into the cache memory 100.

FIG. 2 shows the configuration of the cache memory 100.

The cache memory 100 contains a plurality of indexes 105. Whether a certain address is present or absence in the cache memory 100 is confirmed by an address 106 and a valid bit 107. The valid bit 107 indicates whether or not the corresponding address is valid. When the address is valid, the valid bit is set to, say, a 1. In the absence of an address to be accessed in the cache memory 100 (in the case of cache mis), a data block in that address is read from the main memory 300 into the cache memory 100. In the presence of an address to be accessed in the case memory 100 (in the case of cache hit), data 109 in the cache is directly referenced and processed without accessing the main memory 300. The dirty bit 108 indicates whether or not the contents of corresponding data 109 differs between the main memory 300 and the cache 100. When the dirty bit 108 is set to, say, 1, the contents of corresponding data differ between the main memory 300 and the cache 100.

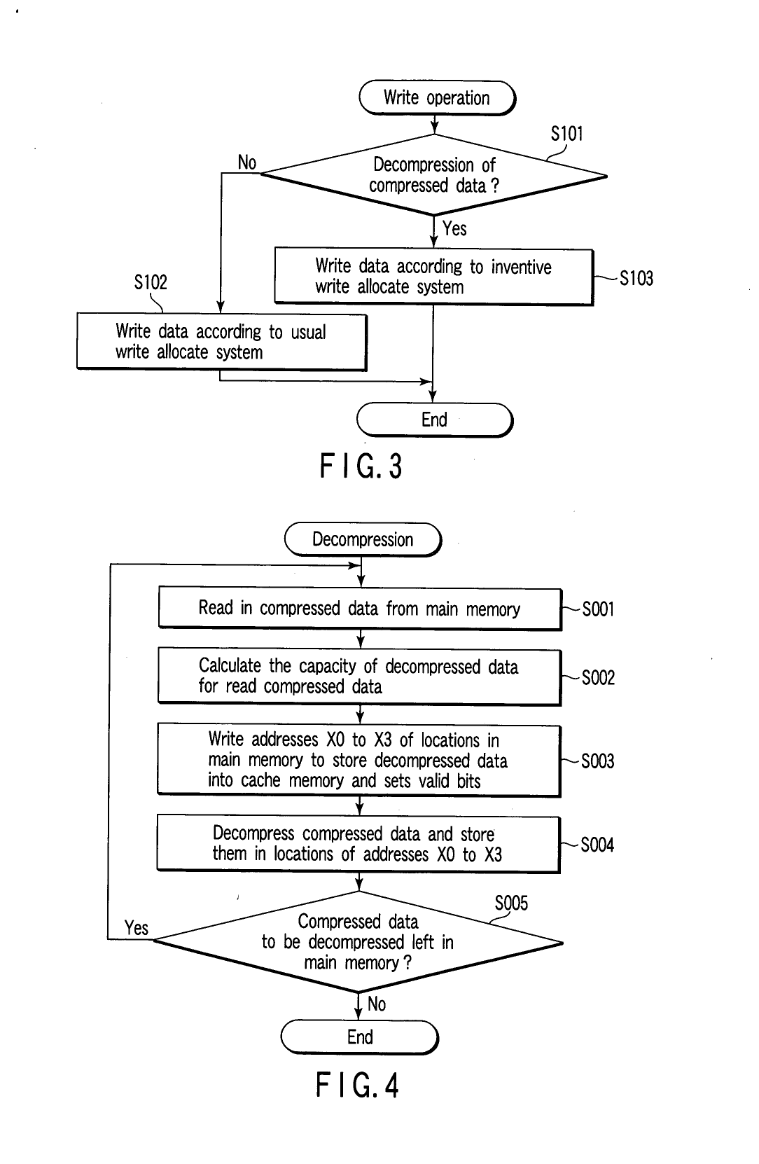

FIG. 3 is a flowchart illustrating an outline of a data write operation including a data decompression operation of the invention.

In writing data into the main memory 300, the CPU 200 makes a decision of whether or not data to be written into is decompressed data in decompression processing (S101). In general, with a device containing a CPU and having various functions built in, CPU control programs are stored with compression on a nonvolatile storage medium, such as a ROM or HDD. In loading the control programs into the main memory 300 at the power-on time or reset time, the CPU decompresses the compressed control programs from the nonvolatile storage medium in accordance with the data compression system of the present invention and then writes the decompressed programs into the main memory 300. In writing decompressed data into the main memory 300 (YES in step S101), the CPU 200 performs a write process based on the write allocate system of the present invention. The CPU 200 controls the entire device in accordance with the control programs stored in the main memory 300. If NO in step S101, data is written into the main memory in accordance with the usual write allocate system.

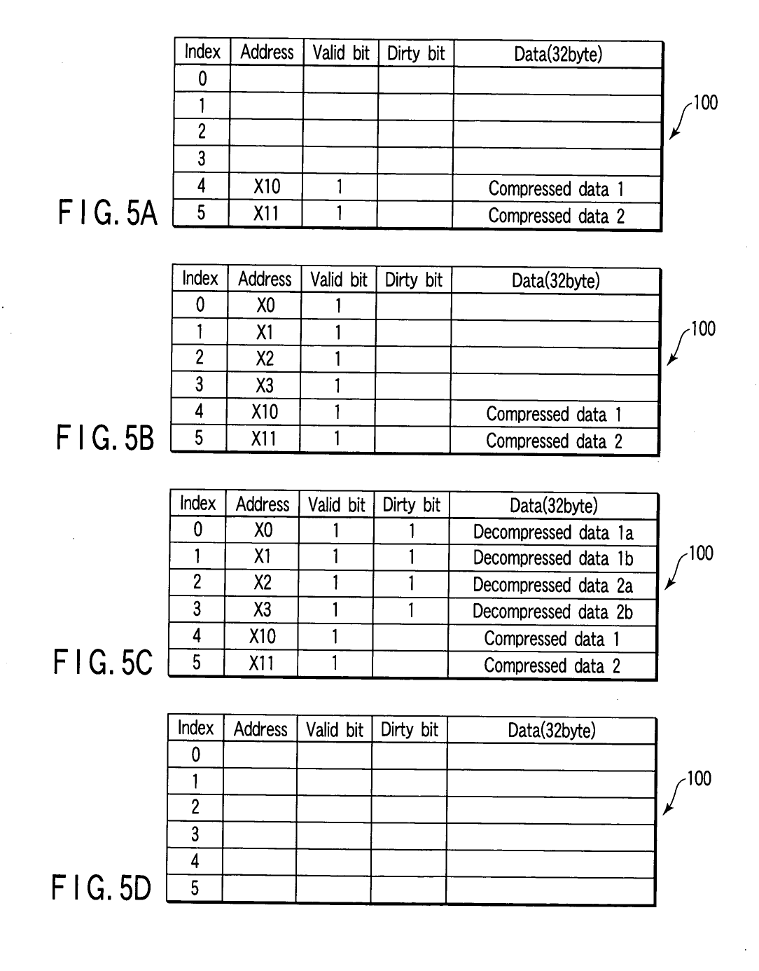

The basic operation of the inventive data compression processing using the write allocate cache 160 will be described next with reference to FIG. 4 illustrating a flowchart and FIGS. 5A, 5B and 5C illustrating the contents of the cache.

First, the CPU 200 reads in compressed data from locations of, say, addresses X10 and X11 in the main memory 300 (step S001). The compressed data may be read in one or more blocks at a time. Suppose here that the CPU reads in two blocks at a time.

At this time, as shown in FIG. 5A, the memory controller 150 writes X10 and X11 into the cache memory 100 as addresses in indexes 4 and 5 in the cache memory, respectively, and sets the corresponding valid bits to 1s. Also, the memory controller 150 reads compressed data 1 and 2 from the locations of addresses X10 and X11 in the main memory 300 and then stores them into the cache memory 100 as data in indexes 4 and 5.

The CPU 200 analyzes the read compressed data 1 and 2 and calculates the amounts of data when the compressed data are decompressed (step S002). The CPU 200 writes the addresses, say, X0 to X3, of locations to store decompressed data in the main memory 300 into the cache memory 100 as addresses in indexes 0 to 3 as shown in FIG. 5B (step S003). The amounts of data stored in the locations of addresses X0 to X3 in the main memory correspond to the amounts of decompressed data calculated in step S002. In step S003, the CPU 200 sets the valid bits in indexes 0 to 3 to 1s.

The CPU 200 next decompresses the compressed data 1 and 2 and then writes decompressed data 1a and 1b for the compressed data 1 and decompressed data 2a and 2b for the compressed data 2 into the locations of the addresses X0 to X3 in the cache memory (step S004). At this time, since the addresses X0 to X3 have already existed in the cache memory (cache hit), the memory controller 150 writes the decompressed data 1a, 1b, 2a and 2b into the cache memory as data in indexes 0 to 3 as shown in FIG. 5C. Further, the memory controller 150 sets the dirty bits in indexes 0 to 3 to 1s. As described above, data read from the main memory 300 and data write to the main memory are actually performed by the memory controller 150 not by the CPU 200.

With the write allocate type of cache memory, upon the occurrence of cache mis, read access is always made to the main memory 300 in order to allocate data in the cache memory. In the case of decompression of compressed data, this read access is wasteful. In the present invention, therefore, in order to write decompressed data the CPU 200 writes the addresses of locations to be written into on the main memory 300 into the cache memory 100 and sets the corresponding valid bits to 1s. As a result, the occurrence of cache mis is prevented, allowing wasteful read access to be avoided. That is, the present invention can avoid wasteful memory read by using instructions that directly operate the cache memory and the CPU apparently setting up blocks corresponding to ones in the main memory within the cache memory.

In step S005, the CPU 200 makes a decision of whether or not compressed data to be decompressed is left in the main memory 300. In the presence of compressed data to be decompressed (YES in step S005), the process returns to step S001 in which the CPU 200 reads next compressed data from the main memory 300. At this time, the memory controller 150 refers to the valid and dirty bits in FIG. 5C, then moves the decompressed data 1a, 1b, 2a, and 2b to the locations of addresses X0 to X3 in the main memory 300 and deletes the compressed data 1 and 2 as shown in FIG. 5C. Next, the main controller 150 reads new compressed data from the main memory 300, then writes the read compressed data and its location address into the cache memory 100 and sets the corresponding valid bit to a 1.

The processes in steps S001 to S005 are repeated until all the compressed data in the main memory 300 are decompressed.

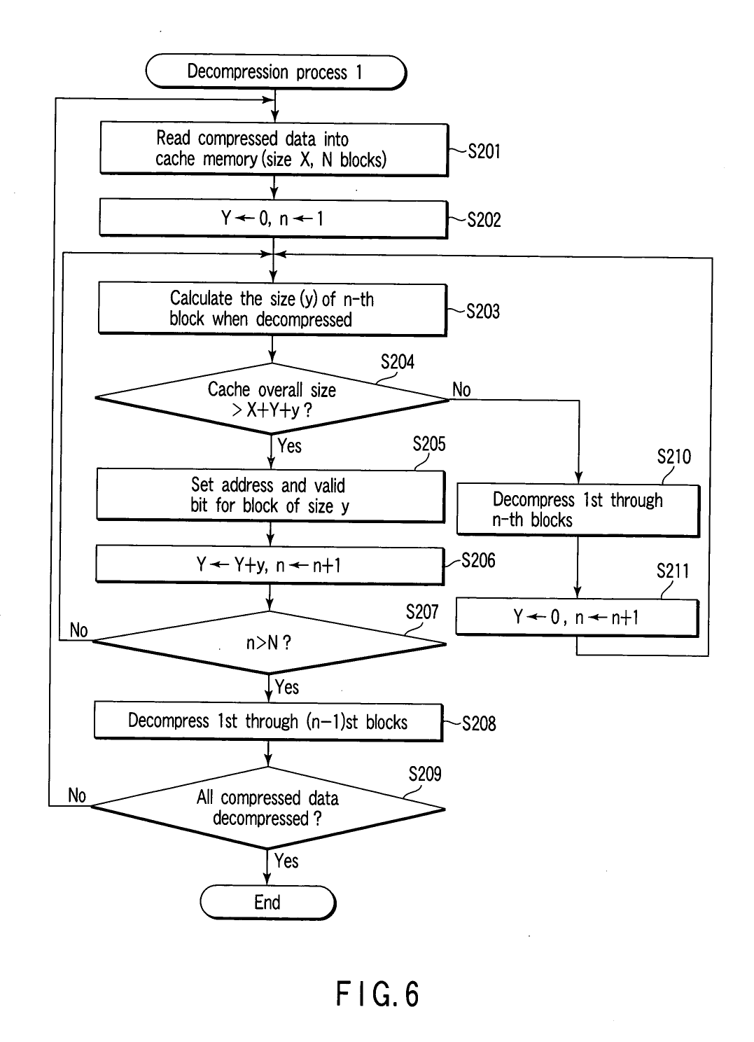

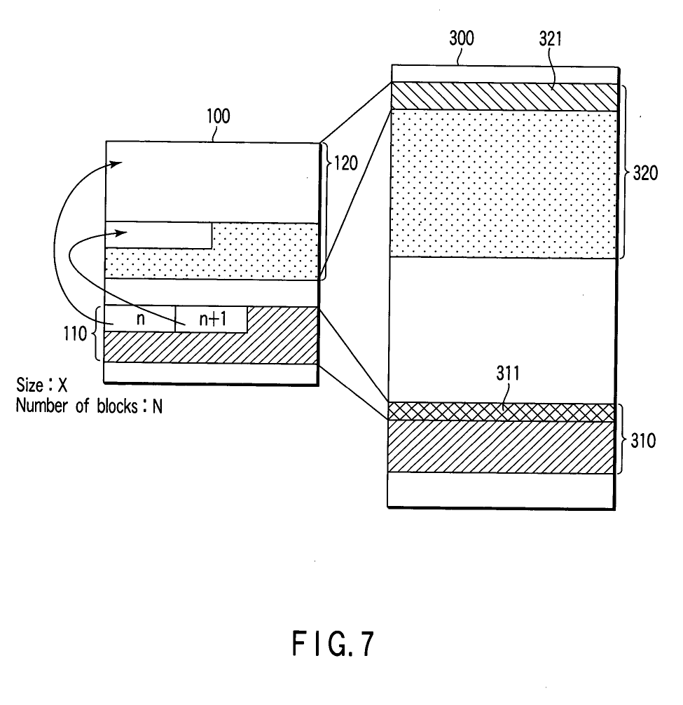

A specific example of the compressed data decompression processing of the present invention will be described next as a first embodiment with reference to FIGS. 6 and 7.

FIG. 6 is a flowchart illustrating the first embodiment of the decompression processing of the present invention. FIG. 7 is a conceptual diagram of the decompression processing. In order to simplify the description, only the data section 109 in FIG. 2 is illustrated in FIG. 7.

As shown in FIG. 7, the main memory 300 is stored with compressed data 310 containing multiple blocks. The main memory 300 is a nonvolatile storage medium, such as a ROM, an HDD, an optical disk, etc. In step S201, N blocks in the compressed data 310 are read by the CPU into the cache memory 100 as compressed data 110 in FIG. 7. Suppose here that the total size of the N blocks is X. In step S202, Y (the sum of decompressed data) is set to 0 and n (the ordinal number of a read block) is set to 1.

Thus, the compressed data have been blocked. The size of data when decompressed varies from block to block. In step S203, the CPU calculates analyzes the contents of the n-th read compressed data block and calculates its data size, y, when decompressed.

In step S204, the CPU 200 decides whether or not cache overall size >X+Y+y. That is, a decision is made as to whether the sum of the size X of compressed data stored in the cache memory, the total value Y of decompressed data and the size y of decompressed data for the n-th block is smaller than the overall size of the cache memory. If YES in step S204, then the CPU writes the address of a location to store decompressed data for the n-th block (X0 and X1 in FIG. 5) into the cache memory and sets the corresponding valid bit to a 1 as shown in FIG. 5B (step S205).

In step S206, Y is set to Y+y and n is set to n+1. In step S207, a decision is made as to whether or not n>N (the number of blocks read in step S201). If NO, then the process returns to step S203. When the calculation of the decompressed size of the N compressed data blocks read in step S201 and recording of the corresponding addresses and valid bits are completed (YES in step S207) by repeating steps S203 through S207, the first through (n−1)st compressed data blocks (N compressed data blocks) are decompressed as shown in FIG. 5C (step S205). Decompressed data 120 shown in FIG. 7 indicates data thus stored. The decompressed data 120 is stored later into the main memory 300 as decompressed data 321.

In step S209, a decision is made as to whether or not all the compressed data 310 stored in the main memory 300 have been decompressed. If NO, a return is made to step S201. Steps S201 through S209 are repeated until all the compressed data 301 are decompressed.

If NO in step S204, that is, if the sum of the size X of compressed data stored in the cache memory, the total value Y of decompressed data and the size y of decompressed data for the n-th block is larger than the overall size of the cache memory, the first through n-th blocks are decompressed in step S210. Thus, decompression processing is performed at the time no free space becomes available in the cache memory 100. In step S211, the total value of decompressed data Y is set to 0 and the ordinal number n of a read compressed data block is set to n+1. The process then goes to step S203. Of the compressed data blocks read in step S201, remaining compressed data not yet decompressed is decompressed (steps S203 through S209). As the result, data decompressed by the CPU 200 is stored into the main memory 300 of FIG. 7 as decompressed data 320.

According to the write allocate cache adopting system of this embodiment, as described above, wasteful memory read (reading of data into the main memory 300) can be omitted in writing decompressed data and decompression processing can be performed in succession using all the capacity of the cache memory 100, thus allowing the processing efficiency of the CPU 200 to be increased.

A second embodiment of the present invention will be described next.

In the first embodiment, the size of compressed data read by the CPU into the cache memory is fixed. By changing the size of compressed data read by the CPU into the cache memory according to the size when decompressed, the cache memory can be used more effectively, allowing fast decompression processing.

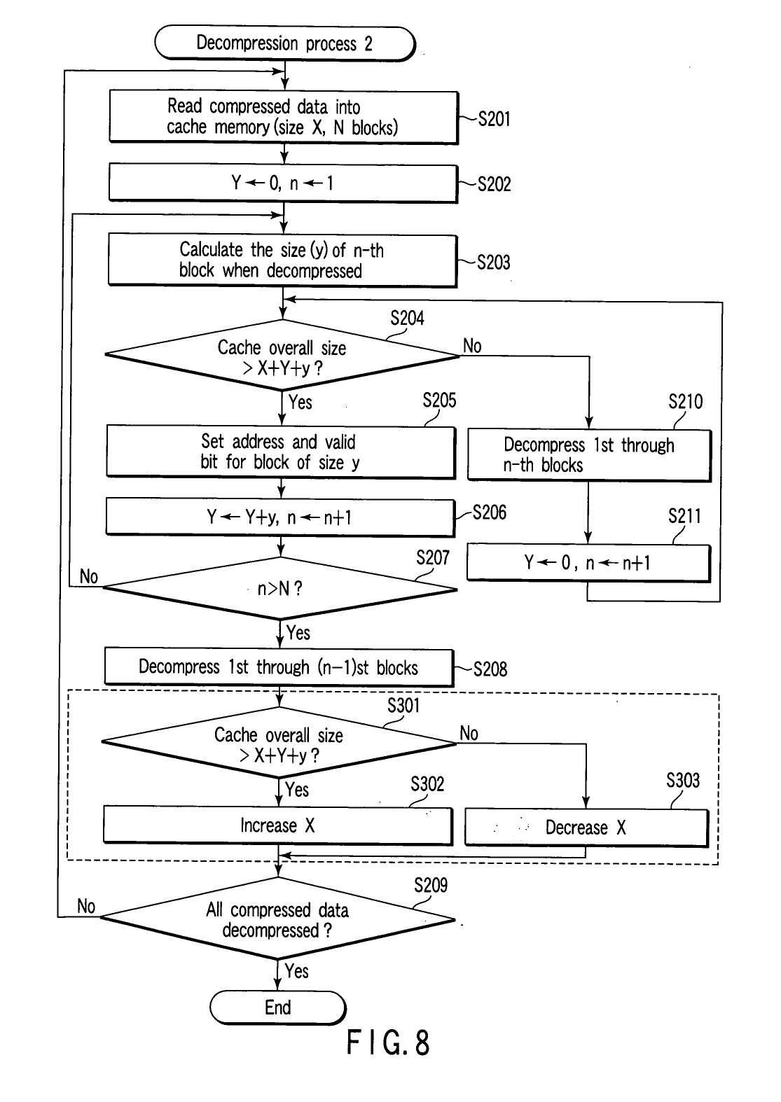

FIG. 8 is a flowchart illustrating decompression processing of the second embodiment. The second embodiment differs from the first embodiment in that steps S301, S302 and S303 enclosed by dotted lines are added.

After the decompression of N compressed data blocks, a decision is made in step S301 as to whether or not the sum of the size X of compressed data stored in the cache memory, the total value Y of decompressed data and the size y of decompressed data for the n-th block is smaller than the overall size of the cache memory. If YES in step S301, then the CPU 200 increases the number X of compressed data blocks to be read in the next decompression processing (step s302). If NO, then the CPU 200 decreases X (step S303).

Thus, by changing the block size X of compressed data to be read by the CPU into the cache memory in the next decompression processing according to the cache memory size (X+Y+y) used at the time of decompression, the cache memory can be used more effectively, allowing fast decompression processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data processing system which has a main memory and a cache memory and processes data in accordance with the write allocate system, comprising:
a read section which reads compressed data from the main memory and stores it into the cache memory;
a calculation section which calculates the capacity of decompressed data corresponding to the compressed data stored in the cache memory;
an ensuring section which ensures an area for storing the calculated amount of data in the cache memory;
a decompression section which decompresses the compressed data stored in the cache memory and storing the decompressed data in the area ensured in the cache memory; and
a move section which moves the decompressed data stored in the cache memory to the main memory.

2. The data processing system according to claim 1, wherein the ensuring section ensures substantially the entire area other than the area for the compressed data stored in the cache memory as the area for storing data of the calculated data amount.

3. The data processing system according to claim 1, wherein the compressed data stored in the main memory is constructed from multiple data blocks, and, if, after N blocks of compressed data have been read, then decompressed and stored into the cache memory, an empty area is present in the cache memory, the read section reads next compressed data blocks the number of which is larger than N from the main memory.

4. The data processing system according to claim 1, wherein the compressed data stored in the main memory is constructed from multiple data blocks, and, if, after N blocks of compressed data have been read, then decompressed and stored into the cache memory, the sum of the capacity of the decompressed data corresponding to the N blocks of compressed data and the capacity of the compressed data stored in the cache memory is larger than the overall capacity of the cache memory, the read section reads next compressed data blocks the number of which is smaller than N from the main memory.

5. The data processing system according to claim 1, wherein the cache memory has multiple data storage areas each storing a predetermined amount of data and multiple address areas each storing the address of a storage location in the main memory for data stored in a corresponding one of the data storage areas, and the ensuring section stores the addresses of storage locations in the main memory for decompressed data decompressed by the decompression section into the address areas.

6. The data processing system according to claim 1, wherein the read section, the calculation section, the ensuring section, the decompression section and the move section are formed as a CPU in one chip.

7. The data processing system according to claim 1, wherein the compressed data is compressed control program data.

8. For use with a data processing system which has a main memory and a cache memory and processes data in accordance with the write allocate system, a method of decompressing compressed data comprising:
reading compressed data from the main memory;
storing the read compressed data into the cache memory;
calculating the capacity of decompressed data corresponding to the compressed data stored in the cache memory;
ensuring an area for storing data of the calculated data amount in the cache memory;
decompressing the compressed data stored in the cache memory;
storing the decompressed data in the area ensured in the cache memory; and
moving the decompressed data stored in the cache memory to the main memory.

9. The data compression method according to claim 8, wherein the ensuring includes ensuring substantially the entire area other than the area for the compressed data stored in the cache memory as the area for storing the calculated amount of decompressed data.
